(19) United States
(12) Patent Application Publication
(10) Pub. No.: US 2025/0214575 A1
(43) Pub. Date: Jul. 3, 2025

(54) Vehicle for Performing Minimal Risk Maneuver and Method for Operating the Vehicle

(71) Applicants: Hyundai Motor Company, Seoul (KR); Kia Corporation, Seoul (KR); Ajou University Industry-Academic Cooperation Foundation, Suwon-si (KR)

(72) Inventors: Jong Sung Park, Hwaseong-Si (KR); Young Bin Min, Hwaseong-Si (KR); Bong Sob Song, Suwon-Si (KR)

(21) Appl. No.: 19/001,968

(22) Filed: Dec. 26, 2024

(30) Foreign Application Priority Data
Dec. 29, 2023 (KR) 10-2023-0196678

(51) Int. Cl. B60W 30/09; B60W 30/095; B60W 30/14; B60W 60/00

(52) U.S. Cl. CPC B60W 30/09; B60W 30/0956; B60W 30/146; B60W 60/0015

(57) ABSTRACT

An apparatus for controlling autonomous driving of a vehicle is introduced. The apparatus may comprise at least one sensor, a controller configured to control operation of the vehicle, a processor configured to be electrically coupled to the at least one sensor and the controller, wherein the processor is further configured to identify, based on a condition for a minimal risk maneuver being satisfied, a minimal risk maneuver type, set, based on the identified minimal risk maneuver type, an allowance space in which the vehicle is able to stop, output a signal associated with the allowance space, and control, based on the signal, autonomous driving of the vehicle such that the vehicle stops within the allowance space.

### CROSS REFERENCE TO RELATED APPLICATION

The present application claims the benefit of priority to Korea Patent Application No. 10-2023-0196678, filed in the Korean Intellectual Property Office on Dec. 29, 2023, the entire contents of which is incorporated herein for all purposes by this reference.

### FIELD

The present disclosure relates to a vehicle configured to execute a minimal risk maneuver, and a method for operating the vehicle.

### BACKGROUND

The matters described in this Background section are only for the enhancement of understanding of the background of the disclosure, and should not be taken as acknowledgment that they correspond to prior art already known to those skilled in the art.

Advanced driver assistance systems (ADAS) are being developed to assist drivers in driving. The ADAS has multiple sub-classifications and provides convenience to the driver. Such ADAS may be autonomous driving or ADS (Automated Driving System).

Meanwhile, an abnormality may occur in the autonomous driving system while the vehicle performs the autonomous driving. The vehicle may get into a dangerous state if appropriate measures are not taken against such abnormality in the autonomous driving system.

### SUMMARY

According to the present disclosure, an apparatus for controlling autonomous driving of a vehicle, the apparatus may comprise at least one sensor, a controller configured to control operation of the vehicle, a processor configured to be electrically coupled to the at least one sensor and the controller, wherein the processor is further configured to identify, based on a condition for a minimal risk maneuver being satisfied, a minimal risk maneuver type, set, based on the identified minimal risk maneuver type, an allowance space in which the vehicle is able to stop, output a signal associated with the allowance space, and control, based on the signal, autonomous driving of the vehicle such that the vehicle stops within the allowance space.

The apparatus, wherein the processor is further configured to for the minimal risk maneuver, select, based on the identified minimal risk maneuver type, one stop type among a stop within lane type, a shoulder stop type, or a straight stop type.

The apparatus, wherein the processor is further configured to, based on the straight stop type being selected, estimate a stopping available distance, a collision risk distance, and a lane departure distance, determine a smallest distance among the estimated stopping available distance, the estimated collision risk distance, and the estimated lane departure distance, wherein the smallest distance is a longitudinal allowable distance, and set, based on the longitudinal allowable distance, the allowance space.

The apparatus, wherein the processor is configured to estimate the stopping available distance based on a relationship among a present vehicle velocity value, a deceleration value applied for the minimal risk maneuver, and a clearance distance value.

The apparatus, wherein the processor is configured to select a collision risk spot at which the vehicle is at risk of colliding based on the vehicle traveling in a straight line, estimate a first distance to the collision risk spot, wherein the first distance is the collision risk distance, select a lane departure spot at which the vehicle is at risk of departing from a lane based on the vehicle traveling in a straight line, and estimate a second distance to the lane departure spot, wherein the second distance is the lane departure distance.

The apparatus, wherein the processor is further configured to set the allowance space further based on a lateral allowable distance, wherein the lateral allowable distance is estimated as a smaller value among a value representing a remaining width of a next lane after subtracting a width of another vehicle traveling in the next lane and a preset constant value from a width of the next lane, and a maximum intrusion allowable range.

The apparatus, wherein the processor is further configured to, based on a determination that the stopping available distance is the longitudinal allowable distance, control, based on a preset deceleration value, the autonomous driving of the vehicle to decelerate for executing the minimal risk maneuver.

The apparatus, wherein the processor is further configured to, based on a determination that the collision risk distance or the lane departure distance is the longitudinal allowable distance, control autonomous driving of the vehicle to advance a time point at which the vehicle starts to decelerate for a minimal risk maneuver, or control autonomous driving of the vehicle to decelerate more rapidly than the preset deceleration value for a minimal risk maneuver.

The apparatus, wherein the processor is further configured to prioritize the control of the autonomous driving of the vehicle to advance the time point over the control of the autonomous driving of the vehicle to decelerate more rapidly than the preset deceleration value.

According to the present disclosure, a method performed by an apparatus for controlling autonomous driving of a vehicle, the method may comprise identifying, based on a condition for a minimal risk maneuver being satisfied, a minimal risk maneuver type, setting, based on the identified minimal risk maneuver type, an allowance space in which the vehicle is able to stop, outputting a signal associated with the allowance space, and controlling, based on the signal, autonomous driving of the vehicle such that the vehicle stops within the allowance space.

The method, wherein the minimal risk maneuver type may comprise at least one of a stop within lane type, a shoulder stop type, or a straight stop type.

The method, wherein the identifying the minimal risk maneuver type may comprise selecting the straight stop type, and wherein the setting the allowance space may comprise estimating a stopping available distance, a collision risk distance, and a lane departure distance, determining a smallest distance among the estimated stopping available distance, the estimated collision risk distance, and the estimated lane departure distance, wherein the smallest distance is a longitudinal allowable distance, and setting, based on the longitudinal allowable distance, the allowance space.

The method, wherein the setting the allowance space may comprise estimating the stopping available distance based on a relationship among a present vehicle velocity value, a deceleration value applied for the minimal risk maneuver, and a clearance distance value.

The method, wherein the setting the allowance space may comprise selecting a collision risk spot at which the vehicle is at risk of colliding based on the vehicle traveling in a straight line, estimating a first distance to the collision risk spot, wherein the first distance is the collision risk distance, selecting a lane departure spot at which the vehicle is at risk of departing from a lane based on the vehicle travelling in a straight line, and estimating a second distance to the lane departure spot, wherein the second distance is the lane departure distance.

The method, wherein the setting the allowance space further may comprise identifying a smaller value among a value representing a remaining width of a next lane after subtracting a width of another vehicle traveling in the next lane and a preset constant value from a width of the next lane, and a maximum intrusion allowable range, and setting, based on the smaller value, the allowance space.

The method, wherein the controlling the autonomous driving of the vehicle may comprise based on a determination that the stopping available distance is the longitudinal allowable distance, controlling, based on a preset deceleration value, the autonomous driving of the vehicle to decelerate for executing the minimal risk maneuver.

The method, wherein the controlling the autonomous driving of the vehicle may comprise based on a determination that the collision risk distance or the lane departure distance is the longitudinal allowable distance, controlling autonomous driving of the vehicle to advance a time point at which the vehicle starts to decelerate for a minimal risk maneuver, or controlling autonomous driving of the vehicle to decelerate more rapidly than the preset deceleration value for a minimal risk maneuver.

The method, wherein the controlling the autonomous driving of the vehicle may comprise prioritizing the controlling the autonomous driving of the vehicle to advance the time point over the controlling the autonomous driving of the vehicle to decelerate more rapidly than the preset deceleration value.

The method, wherein the stopping available distance increases as the present vehicle velocity value increases, and wherein the stopping available distance decreases as the deceleration value increases.

The method, wherein the preset constant value may comprise a clearance constant value of 0.75 meter.

### BRIEF DESCRIPTION OF THE DRAWINGS

FIG. 1 shows an example of a vehicle according to various examples of the present disclosure.

FIG. 2 shows an example of minimal risk maneuver (MRM) types according to various examples of the present disclosure.

FIG. 3 shows an example of operations of a vehicle according to various examples of the present disclosure.

FIG. 4 shows an example of a flowchart for stopping a vehicle according to a minimal risk maneuver by a vehicle according to various examples of the present disclosure.

FIG. 5 and FIG. 6 show examples of predicting an allowance space for executing a minimal risk maneuver.

### DETAILED DESCRIPTION

Hereinafter, examples are described in more detail with reference to accompanying drawings.

The construction and operational effect of the present disclosure will be clearly understood from the following detailed description. Prior to describing examples of the present disclosure in detail, it is noted that throughout the drawings the same components will be denoted by the same reference numerals when possible and a detailed description about existing components and functions is omitted when the subject matter of the present disclosure may be obscured by the description.

It is also noted that terms used in the detailed description of the present disclosure are defined below.

The vehicle refers to a vehicle in which the automated driving system (ADS) is provided and is capable of the autonomous driving. For example, by the ADS, the vehicle may perform at least one among steering, acceleration, deceleration, lane change and vehicle stopping (short stop) without a driver's manipulation. For example, the ADS may include at least one among Pedestrian Detection and Collision Mitigation System (PDCMS), Lane Change Decision Aid System (LCDAS), Land Departure Warning System (LDWS), Adaptive Cruise Control (ACC), Lane Keeping Assistance System (LKAS), Road Boundary Departure Prevention System (RBDPS), Curve Speed Warning System (CSWS), Forward Vehicle Collision Warning System (FVCWS), and Low Speed Following (LSF).

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., features of an allowance space) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of an allowance space) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of an allowance space) described herein.

Minimum risk maneuver (MRM) operation(s) may also be controlled, for example, based on one or more features (e.g., features of an allowance space) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of an allowance space) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of an allowance space) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

A driver is a human being who uses a vehicle, and is provided with a service of an autonomous driving system.

The vehicle control authority is an authority to control at least one component of the vehicle and/or at least one function of the vehicle. At least one function of the vehicle may include, for example, at least one among steering, acceleration, deceleration (or braking), lane change, lane detection, lateral control, obstacle recognition and distance detection, powertrain control, safe area detection, engine on/off, power on/off, and vehicle lock/unlock. The listed functions of the vehicle are merely examples for helping understanding, and examples of the present disclosure are not limited thereto.

A shoulder may mean a space between an outermost road boundary (or a boundary of an outermost lane) in a direction in which a vehicle is traveling and a road edge (e.g., curb, guardrail). That is, the shoulder is a part of a road installed in an edge of the road, and may mean a space for allowing a vehicle in an emergency to stop therein, for allowing a vehicle in an emergency to take a roundabout way from traffic congestion, or for allowing a vehicle to enter to leave from the traffic congestion.

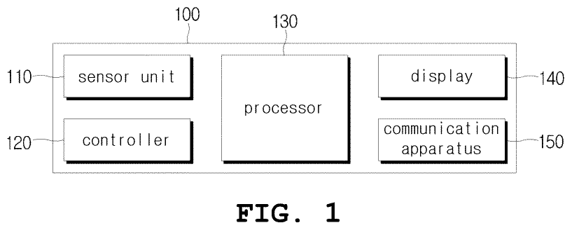

FIG. 1 shows an example of a vehicle according to various examples of the present disclosure.

The configuration of the vehicle illustrated in FIG. 1 is one example, and each component may be configured as one chip, one component, or one electronic circuit, or a combination of chips, components and/or electronic circuits. According to the example, some of the components illustrated in FIG. 1 may be divided into a plurality of components and configured as different chips, different components, or different electronic circuits, and some components may be combined to form one chip, one component, or one electronic circuit. According to the example, some of the components illustrated in FIG. 1 may be omitted or other components not illustrated may be added. At least some of the components of FIG. 1 will be described with reference to the following drawings.

Referring to FIG. 1, the vehicle 100 may include a sensor unit 110, a controller 120, a processor 130, a display 140, and a communication apparatus 150.

According to various examples, the sensor unit 110 may sense a surrounding environment of the vehicle 100 using at least one sensor, and generate data related to the surrounding environment based on the sensed result. For example, the sensor unit 110 may obtain information on objects around the vehicle (for example, other vehicle, a person, an object, a curb, a guardrail, a lane, an obstacle) based on the sensed data obtained from at least one sensor. Information on the object around the vehicle may include at least one among a position of the object, a size of the object, a shape of the object, a distance to the object, and a relative speed to the object. As another example, the sensor unit 110 may measure a position of the vehicle 100 using at least one sensor. The sensor unit 110 may include, for example, at least one selected among a camera, a light detection and ranging (LIDAR) sensor, a radio detection and ranging (RADAR) sensor, an ultrasonic sensor, an infrared sensor, and a position measurement sensor. The listed sensors are merely examples for helping understanding, and the sensors included in the sensor unit 110 of the present disclosure are not limited thereto.

According to the example, a camera may generate image data which includes an object positioned in front, at a rear and on a side of the vehicle 100, by capturing image around the vehicle. According to the example, the lidar may generate information on an object positioned in front, on a rear side and/or on a side of the vehicle 100 using light (or laser). According to the example, the radar may generate information on an object positioned in front, on a rear side and/or on a side of the vehicle 100 using electromagnetic waves (or radio waves). According to the example, the ultrasonic sensor may generate information on an object positioned in front, on a rear side and/or on a side of the vehicle 100 using ultrasonic waves. According to the example, the infrared sensor may generate information on an object positioned in front, on a rear side and/or on a side of the vehicle 100 using infrared rays.

According to the example, the position measurement sensor may measure the current position of the vehicle 100. The position measurement sensor may include at least one among a Global Positioning System (GPS) sensor, a Differential Global Positioning System (DGPS) sensor and a Global Navigation Satellite System (GNSS) sensor. The position measurement sensor may generate position data of the vehicle based on a signal generated by at least one among a GPS sensor, DGPS sensor and GNSS sensor.

According to various examples, the controller 120 may control operation of at least one component of the vehicle 100 and/or at least one function of the vehicle according to the control of the processor 130. The at least one function may be, for example, at least one among a steering function, an acceleration function (or a longitudinal acceleration function), a deceleration function (or a longitudinal deceleration function, a brake function), a lane change function, a lane detection function, an obstacle recognition and a distance detection function, a lateral control function, a powertrain control function, a safety zone detection function, an engine on/off, a power on/off, and a vehicle lock/unlock function.

According to the example, the controller 120 may control at least one component of the vehicle and/or at least one function of the vehicle for autonomous driving and/or a minimal risk maneuver (MRM) of the vehicle 100 according to the control of the processor 130. For example, for the minimal risk maneuver, the controller 120 may control the operation of at least one function among a steering function, an acceleration function, a deceleration function, a lane change function, a lane detection function, a lateral control function, an obstacle recognition and distance detection function, a powertrain control function, and a safe zone detection function.

According to various examples, the processor 130 may control the overall operation of the vehicle 100. According to the example, the processor 130 may include an electrical control unit (ECU) capable of integrally controlling components in the vehicle 100. For example, the processor 130 may include a central processing unit (CPU) or a micro processing unit (MCU) capable of performing arithmetic processing.

According to various examples, when a specified event is generated, the processor 130 may activate the Automated Driving System (ADS) to control components in the vehicle 100 such that the vehicle performs autonomous driving. The specified event may be generated when autonomous driving of the driver is requested, vehicle control authority from the driver is delegated, or a condition specified by the driver and/or designer is satisfied.

The processor 130 may determine whether the normal autonomous driving is possible based on at least one among vehicle status information and surrounding environment information, during the autonomous driving. According to an example, from the time when ADS is activated, the processor 130 may obtain vehicle state information indicating whether mechanical and/or electrical faults of components inside the vehicle occur or not, by monitoring mechanical and/or electrical states of components inside the vehicle (e.g., sensors, actuators and the like). The vehicle state information may include information about mechanical states and/or electrical states of components inside the vehicle. For example, the vehicle state information may include information indicating whether functions necessary for autonomous driving may normally operate or not according to mechanical and/or electrical states of components inside the vehicle. According to an example, the processor 130 may obtain environment information around the vehicle through the sensor unit 110, from the time when ADS is activated.

The processor 130 may determine whether functions necessary for autonomous driving are normally operable based on the vehicle state information. Functions required for autonomous driving may include, for example, at least one among a lane detection function, a lane change function, a lateral control function, a deceleration (or brake control) function, a powertrain control function, a safe area detection function, an obstacle recognition function, and a distance sensing function. When the normal operation of at least one among the functions required for autonomous driving is impossible, the processor 130 may determine that normal autonomous driving is impossible.

The processor 130 may determine whether the vehicle state is suitable for general driving conditions based on the vehicle state information. For example, the processor 130 may determine whether the vehicle's mechanical state information (e.g., tire pressure information or engine overheat information) is suitable for general driving conditions. When the vehicle state is not suitable for general driving conditions, the processor 130 may determine that normal autonomous driving is impossible.

The processor 130 may determine whether an environment around the vehicle is suitable for an operation design domain (ODD) of autonomous driving based on at least one among the surrounding environment information. The operation design domain may represent a condition for the surrounding environment in which autonomous driving normally operates. The processor 130 may determine that normal autonomous driving is impossible when the surrounding environment information of the vehicle does not match the operation design domain.

According to various examples, when the normal autonomous driving is impossible, the processor 130 may determine it as a situation in which the MRM to minimize the risk of an accident is required. The processor 130 may determine the MRM type in a situation in which the MRM execution is needed.

The processor 130 may determine that the MRM to minimize the risk of an accident is required when an abnormal signal with respect to the driver is sensed or the emergency stop is required even in a state in which the ADS system operates normally. The abnormal signal with respect to the driver may include a case in which an anomaly occurs in the bio-signal, or a case in which there is no reaction of the driver to a handover request. The emergency stop may be requested by the driver, or a third party such as a policeman.

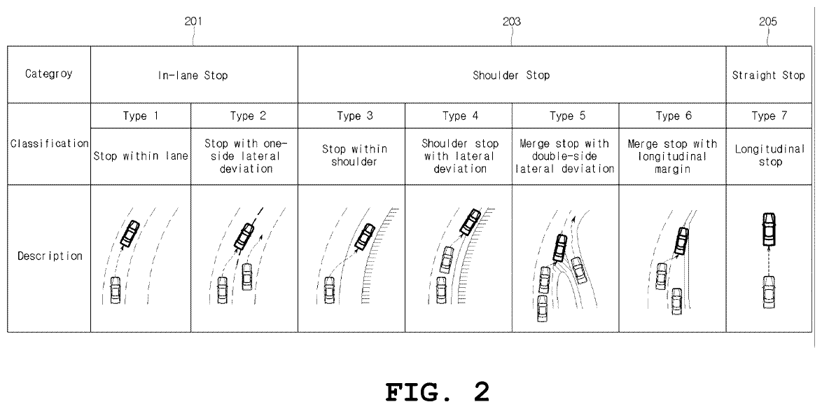

Referring to FIG. 2 which shows an example of the minimal risk maneuver (MRM) types according to various examples of the present disclosure, the minimal risk maneuver (MRM) types may include an in-lane stop type 201, a shoulder stop type 203, and a straight stop type 205.

The in-lane stop type 201 may include stop within lane which is Type 1, in which the vehicle stops within a boundary of the lane in which it is traveling, and stop with one-side lateral deviation which is Type 2, in which the vehicle stops while partially getting out of the lane on one side.

For example, the in-lane stop type 201 may mean a type in which the vehicle stops within a boundary of the lane in which it is traveling, or the vehicle stops while partially getting out of the boundary of the lane through the lateral control and/or deceleration. The lane in which the vehicle is traveling may mean the lane in which the vehicle is traveling at a time point when it is determined that the MRM execution is required.

The shoulder stop type 203 may include stop within shoulder which is Type 3, in which the vehicle fully enters the shoulder and stops on the shoulder, shoulder stop with lateral deviation which is Type 4, in which the vehicle stops over the lane and the shoulder, merge stop with double-side lateral deviation which is Type 5, in which the vehicle stops on a shoulder at a point where a road joins another road, and merge stop with longitudinal margin which is Type 6, in which the vehicle stops on a shoulder near a point where the lane disappears.

For example, the shoulder stop type 203 may mean a type in which the vehicle stops in a state in which a portion of the vehicle or the whole vehicle is located on a shoulder after moving to be out of a road boundary (or boundary of the outermost lane) through longitudinal acceleration, longitudinal deceleration, and/or lateral control.

The straight stop type 205 may include longitudinal stop, which is Type 7, in which the vehicle travels in a straight line, instead of traveling along the lane, and then, stops.

The straight stop type 205 is a type in which the vehicle stops by using deceleration in a longitudinal direction only, and does not require lateral control. For example, the straight stop type may be executed in a situation where the lane detection is impossible, or where the lateral control is impossible due to a defect of an actuator for the lateral control.

The processor 130 may determine one among the in-lane stop type 201, the shoulder stop type 203, and the straight stop type 205 based on at least one among vehicle state information, surrounding environment information, and the Road Traffic Act.

According to an example, the processor 130 may determine the MRM type based on a basic type predetermined by the designer, regardless of vehicle state information, surrounding environment information, and the Road Traffic Act. The predetermined basic type may be the shoulder stop type 203. This is because the Road Traffic Act permits or recommends the vehicle to stop on a shoulder which is relatively safer area, in case where an emergency occurs due to a defect of the vehicle and the likes. Therefore, various examples of the present disclosure predetermine the shoulder stop type 203 to be the basic type, thereby minimizing an effect of the MRM on the traffic flow, minimizing possibility of a second collision, and allowing the driver or passenger to escape to be out ofthe road.

According to an example, the processor 130 may determine the shoulder stop type 203 to be the MRM type when the ADS system operates normally, but the vehicle state is not suitable for the normal driving conditions. For example, the processor 130 may determine the shoulder stop type 203 to be the MRM type when the ADS system operates normally, but battery overheat or tire puncture is sensed.

According to an example, the processor 130 may determine the shoulder stop type 203 to be the MRM type when an abnormal signal with respect to the driver is sensed, or emergency stop is required.

According to an example, when the shoulder stop type 203 is determined to be the MRM type, the processor 130 may move the vehicle toward a shoulder of a road through lateral and/or longitudinal control, and may control position of the vehicle such that at least a portion of the vehicle positions on a shoulder of a road.

According to an example, the processor 130 may change the MRM type when there is no shoulder of a road, on which stopping is possible, within a specified threshold range, based on the current position of the vehicle 100. For example, the processor 130 may change the MRM type to the in-lane stop type 201, then, perform the vehicle stopping.

According to an example, the processor 130 may determine whether the vehicle stopping within the lane is completed within a specified time, and may determine whether to change the MRM type based on the determination. The processor 130 may change the MRM type to the in-lane stop type 201 when the vehicle stopping within the lane is not completed within the specified time. For example, the processor 130 may change the MRM type from the shoulder stop type 203 to the in-lane stop type 201 when the vehicle stopping within the lane is not completed within the specified time so as to control the vehicle such that the vehicle stopping within the lane is performed. When the vehicle stopping within the lane is not completed within the specified time, the processor 130 may change the MRM type from the in-lane stop type 201 to the straight stop type 205 so as to control the vehicle such that the straight stop is performed.

According to various examples, the processor 130 may perform operations for stopping the vehicle according to the determined MRM type, and determine whether the Minimal Risk Condition (MRC) is satisfied. MRC may mean a stopped state in which the vehicle speed is 0. For example, the processor 130 may determine whether the vehicle 100 gets into a stopped state in which the speed of the vehicle 100 is 0 while performing at least one operation according to the determined MRM type. When the vehicle 100 gets into a state where the speed is 0, the processor 130 may determine that the MRC is satisfied.

According to various examples, when the MRC is satisfied, the processor 130 may end the MRM operation and switch the autonomous driving system (ADS) to a standby mode or an off-state. According to the example, the processor 130 may control the autonomous driving system (ADS) to be transferred to the driver (or user) after switching the autonomous driving system (ADS) to the standby mode or off-state.

According to various examples, the display 140 may visually display information related to the vehicle 100. For example, the display 140 may provide various information related to the state of the vehicle 100 to the driver of the vehicle 100 under the control of the processor 130. The various information related to the state of the vehicle may include at least one among information indicating whether various components included in the vehicle and/or at least one function of the vehicle are normally operated, and information indicating the driving state of the vehicle. The driving state of the vehicle may include, for example, at least one among a state in which the vehicle is autonomously driving, a state in which the MRM is underway, a state in which the MRM is completed, and a state in which autonomous driving is ended.

According to various examples, the communication apparatus 150 may communicate with an external device of the vehicle 100. According to examples, the communication apparatus 150 may receive data from the external device of the vehicle 100 or transmit data to the external device of the vehicle 100 under the control of the processor 130. For example, the communication apparatus 150 may perform communication using a wireless communication protocol or a wired communication protocol.

In FIG. 1 described above, the controller 120 and the processor 130 have been described as separate components, but according to various examples, the controller 120 and the processor 130 may be integrated into one component.

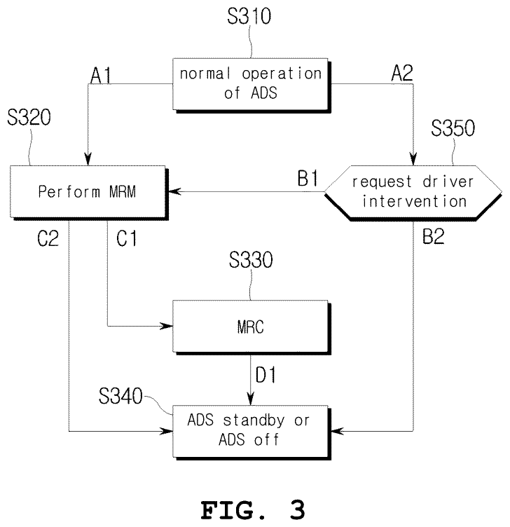

FIG. 3 shows an example of operations of a vehicle according to various examples of the present disclosure. For convenience, FIG. 3 is described by way of an example in which the steps are performed by a processor (e.g., control circuitry). One, some, or all steps of FIG. 3, or portions thereof, may be performed by one or more other circuits. One or some, steps of FIG. 3 may be omitted, performed in other orders, and/or otherwise modified, and/or one or more additional steps may be added.

Referring to FIG. 3, the vehicle 100 may normally operate the ADS in an operation S310.

According to the example, the vehicle 100 may monitor the vehicle state and the surrounding environment while performing the autonomous driving according to normal operation of the ADS. The vehicle 100 may sense whether the MRM is required based on information obtained by monitoring the vehicle state and the surrounding environment. If the MRM is required, an event A1 may be generated.

According to the example, the vehicle 100 may sense whether the driver (or user) intervention is required while performing the autonomous driving according to the normal operation of the ADS. When driver intervention is required, the vehicle 100 may perform a Request To Intervene (RTI) through the ADS or issue a warning. The driver intervention request or warning may be an event A2. The vehicle 100 may proceed to an operation S320 when the event A1 occurs in a state in which the ADS is normally operated.

When the event A2 occurs in a state in which the ADS operates normally, the vehicle 100 may request the driver intervention in an operation S350 and determine whether the driver intervention is sensed within a specified time. The vehicle 100 may determine that an event B1 has occurred when no driver intervention is sensed within the specified time. When the event B1 occurs, the vehicle 100 may proceed to an operation S320. The vehicle 100 may determine that an event B2 has occurred when the driver intervention is sensed within a specified time. When the event B2 occurs, the vehicle 100 may proceed to an operation S340.

The vehicle 100 may perform the MRM in the operation S320. According to an example, the vehicle 100 may determine the MRM type based on at least one among the vehicle state information, the surrounding environment information, and the Road Traffic Act. According to an example, the processor 130 may determine the MRM type based on a basic type predetermined by the designer, regardless of vehicle state information, surrounding environment information, and the Road Traffic Act. The predetermined basic type may be the shoulder stop type 203. The MRM types, as illustrated in FIG. 2, may be one among the in-lane stop type 201, the shoulder stop type 203, and the straight stop type 205.

The vehicle 100 may control at least one component in the vehicle to stop the vehicle according to the determined MRM type. According to an example, the vehicle 100 may notify information indicating that the vehicle executes the MRM to another vehicle.

The vehicle 100 may determine whether the minimal risk requirement is satisfied as the speed of the vehicle becomes 0 by performing the MRM in the operation S320. When the minimal risk requirement is satisfied, the vehicle 100 may determine that an event C1 has occurred and proceed to an operation S330. The vehicle 100 may determine whether the driver's intervention is sensed while the MRM is underway. When the driver's intervention is sensed, the vehicle 100 may determine that an event C2 has occurred and proceed to the operation S340.

In the operation S330, the vehicle 100 may maintain a state in which the minimal risk requirement is satisfied. The state in which the minimal risk requirement is satisfied may mean a state in which the vehicle is stopped. For example, the vehicle 100 may maintain a stopped state. For example, the vehicle 100 may perform control operation for maintaining the vehicle in a stopped state regardless of an inclination of a road surface at the stopped location. The vehicle 100 may determine whether an event D1 occurs while maintaining a state in which the minimal risk requirement is satisfied. An event D1 may include at least one among ADS being turned off the by the driver, and completion to transfer the vehicle control authority to the driver. When the event D1 occurs, the vehicle 100 may proceed to the operation S340.

The vehicle 100 may switch the ADS into a standby mode or an off-state in the operation S340. The vehicle 100 may not perform operation for the autonomous driving while the ADS is in a standby mode or an off-state.

The operations S310, S320, S330, and S350 described above may be in a state in which the ADS is activated, and the operation S340 may be in a state in which the ADS is inactive.

Hereinafter, operations of the vehicle for executing the MRM in the operation S320 will be described in greater detail. In particular, operations for executing the MRM when the MRM type is the straight stop will be described in greater detail.

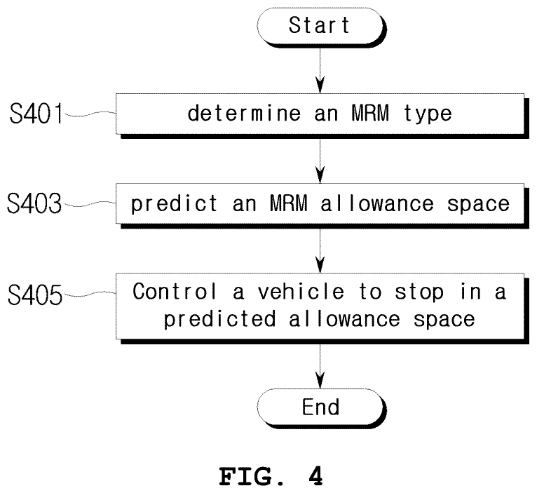

FIG. 4 shows an example of a flowchart for stopping the vehicle according to the minimal risk maneuver by the vehicle according to various examples of the present disclosure. For convenience, FIG. 4 is described by way of an example in which the steps are performed by a processor (e.g., control circuitry). One, some, or all steps of FIG. 4, or portions thereof, may be performed by one or more other circuits. One or some, steps of FIG. 4 may be omitted, performed in other orders, and/or otherwise modified, and/or one or more additional steps may be added.

The operations of FIG. 4 may be detailed operations of the operation S320 of FIG. 3. In particular, the operations of FIG. 4 may be the MRM operations when the straight stop is determined to be the MRM type. In the example in FIG. 4, each operation may be sequentially performed, but may be not necessarily performed sequentially. For example, the order of each operation may be changed, and at least two operations may be performed in parallel. In addition or alternatively, the operations in FIG. 4 may be performed by the processor 130 and/or the controller 120 provided in the vehicle 100 or implemented as instructions executable by the processor 130 and/or the controller 120.

The flowchart in FIG. 4 shows examples of stopping the vehicle according to the MRM; however, according to another example, the flowchart in FIG. 4 may be used the same or similarly when the vehicle executes the vehicle stopping according to a request of the user, even if the situation does not require the MRM.

Referring to FIG. 4, the vehicle 100 may determine the MRM type in an operation S401.

According to an example, although the ADS system operates normally, the vehicle 100 may execute operations of the MRM when it is confirmed that the vehicle state is not suitable for the general driving conditions, based on the vehicle state information, and/or the surrounding environment information. In addition or alternatively, the vehicle 100 may execute operations of the MRM when an abnormal signal with respect to the driver is sensed or the emergency stop requested by the driver is sensed.

According to various examples of the present disclosure, the vehicle 100 may select the straight stop type as the MRM type for executing the MRM operations based on the vehicle state information, and/or the surrounding environment information. According to an example, the vehicle 100 may select the straight stop type as the MRM type when the vehicle 100 may conduct the brake control, but cannot conduct the lateral control, or when the lane is not detected or the shoulder is not detected.

The vehicle 100 may predict an allowance space (e.g., an MRM allowance space) in an operation S403. The MRM allowance space may mean a space in which the vehicle 100 may stop according to the operations of the MRM. For example, an allowance space may refer to a dynamically determined safe area where a vehicle may stop during the operations of the MRM. The allowance space may combine longitudinal and lateral allowable distances to ensure safe stopping under varying conditions. The longitudinal distance may be determined as the smallest value among a stopping available distance (based on speed and deceleration), a collision risk distance (distance to obstacles), and a lane departure distance (distance before exiting a lane). The lateral distance may account for the width of neighboring lanes, subtracting the width of adjacent vehicles and a clearance constant (e.g., 0.75 m), or using a maximum allowable intrusion. The allowance space may be determined in real-time using sensor data, vehicle state, and environmental factors, ensuring the vehicle may safely stop while avoiding collisions or lane departures.

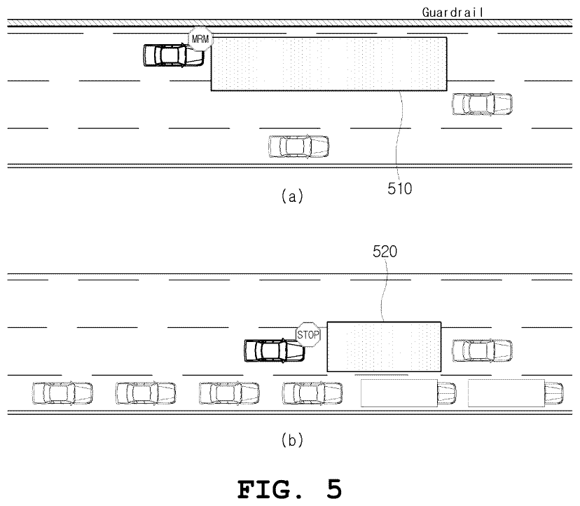

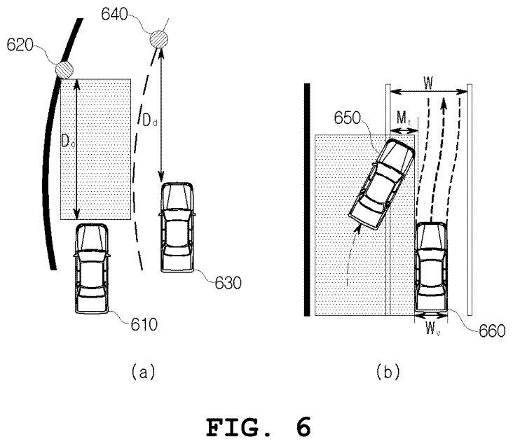

FIG. 5 and FIG. 6 show examples of predicting an allowance space for executing the MRM.

Referring to FIG. 5, the vehicle 100 may predict the MRM allowance spaces 510 and 520 based on information on a guardrail, position/speed information on a vehicle in front and a neighboring vehicle. In addition or alternatively, the vehicle 100 may improve performance of predicting the MRM allowance space in consideration of the positioning information and map information additionally, and improve performance of predicting the MRM allowance space by predicting traveling trajectories of the own vehicle and the vehicle in front. According to an example, prediction of the MRM allowance space may be performed through artificial intelligence.

Referring to FIG. 6, the vehicle 100 may predict a longitudinal allowable distance D_{long} and a lateral allowable distance Dₗₐₜ so as to predict the MRM allowance space.

According to an example, the vehicle 100 may predict a stopping available distance Dₛ, a collision risk distance D_{c}, and/or a lane departure distance D_{d} so as to predict the longitudinal allowable distance D_{long}.

According to an example, the vehicle 100 may predict the stopping available distance Dₛ by using an equation 1 below, based on a present vehicle velocity v, deceleration α for the MRM, and a clearance δ.

$${D}_{s} = \frac{{v}^{2}}{2 α} + δ \qquad [ Equation 1 ]$$

In a state in which the straight stop type is selected as the MRM type, and a guardrail exists on a left side like a vehicle 610 in the first lane in FIG. 6, when a road is formed to be straight, there exists a spot at which the traveling trajectory on which the vehicle 610 travels and the guardrail intersect and the spot may be selected as a collision risk spot 620. In addition or alternatively, the vehicle 610 may select the collision risk spot 620 more precisely in consideration of a width of the vehicle. Further, a distance within the traveling trajectory from the current position to the selected collision risk spot 620 may be defined as the collision risk distance D_{c}.

According to another example, in a state in which the straight stop type is selected as the MRM type, there exists a spot at which a predicted traveling trajectory and the lane in which the vehicle 630 travels meet each other when a road is curved, and the spot may be selected as a lane departure spot 640. In addition or alternatively, the vehicle 630 may select the lane departure spot 640 more precisely in consideration of a width of the vehicle.

Then, a distance from the current position to the lane departure spot 640 may be defined as the lane departure distance D_{d}.

The vehicle 100 may define the minimum value (min(Dₛ, D_{c}, D_{d})) among the stopping available distance Dₛ, the collision risk distance D_{c}, and the lane departure distance D_{d} as the longitudinal allowable distance D_{long}.

Referring to (b) of FIG. 6, a width W of the lane and the maximum intrusion allowable range (e.g., 1 m) may be defined so as to predict the lateral allowable distance Dₗₐₜ of the MRM.

When the vehicle stops by the MRM, according to an example, the vehicle 650 may intrude into the next lane. For example, even if the straight stop type is selected as the MRM type, when the steering direction heads for the next lane, it is likely that the vehicle intrudes into the next lane by moving toward a side direction gradually although the vehicle proceeds forward in a state in which a tire on one side is punctured. In addition or alternatively, when the stop within lane type is selected as the MRM type, the stop within a lane may be possible while allowing intrusion into the next lane.

In such a case, a next lane intrusion allowable range Mₜ must ensure a vehicle traveling in the next lane may travel while avoiding the stopped vehicle without changing the lane. That is, a space (W−Mₜ) allowing a vehicle in the next lane to escape, of the lane width W of the next lane, must be greater than a value obtained by adding 0.75 m to the vehicle width Wᵥ of the vehicle traveling in the next lane (Wᵥ+0.75 m). Accordingly, a smaller value among a value of an equation, (a width of a next lane W−a width of a vehicle traveling in the next line Wᵥ−0.75 m) and the maximum intrusion allowable range (e.g., 1 m) may be determined as the next lane intrusion allowable range Mₜ.

The lateral allowable distance Dₗₐₜ may be determined based on a position of the vehicle 100 within the lane. When a center of the vehicle 100 is positioned at Xₗₐₜ meter from a left starting point of the lane in which the vehicle 100 travels, a left lateral allowable distance D_{lat,l} of the vehicle 100 may be predicted or determined to be a value of an equation, (Xₗₐₜ−Wᵥ/2+Mₜ), and a right lateral allowable distance D_{lat,r} of the vehicle 100 may be predicted or determined to be a value of an equation, (W−Xₗₐₜ−Wᵥ/2+Mₜ). Here, Wv refers to a width of a vehicle, and it is possible to set Wv to be one value per kind (a small-size vehicle, a midsize vehicle, a large-size vehicle), or one value for all kinds of vehicles. Mₜ is the next lane intrusion allowable range obtained in the above description.

The vehicle 100 may predict the MRM allowance space based on the longitudinal allowable distance D_{long}, the left lateral allowable distance D_{lat,l}, and the right lateral allowable distance D_{lar,r}.

Referring to FIG. 4 again, it is possible to control the vehicle 100 to stop in the predicted or determined allowance space in an operation S405.

According to an example, when the longitudinal allowable distance D_{long} is determined to be the stopping available distance Dₛ, the vehicle 100 may decelerate at a specified deceleration. According to an example, deceleration (e.g., −4 m/s²) for the MRM may be set to be the specified deceleration.

According to an example, when the collision risk distance D_{c} or the lane departure distance D_{d} is determined to be the longitudinal allowable distance D_{long}, stopping within the allowance space may be impossible when the vehicle 100 decelerates at the specified deceleration. Therefore, in order to stop the vehicle within the allowance space, additional vehicle control may be necessary.

According to an example, the vehicle 100 may change a time point at which the vehicle starts to decelerate. For example, it may be set that the vehicle starts to decelerate after a taillight flickers for 3 seconds when the MRM is triggered, however, the vehicle 100 may starts to decelerate upon the MRM is triggered, so as to stop within the allowance space. In addition or alternatively, when the MRM is triggered, as soon as calculation of the allowance space is completed, the vehicle 100 may start to decelerate.

According to another example, the vehicle 100 may control the deceleration so as to stop within the allowance space. For example, the deceleration (e.g., −4 m/s²) for the MRM is set to be the specified deceleration, however, it is possible to decrease a braking distance by increasing the deceleration so that the vehicle may decelerate more rapidly than the specified deceleration.

However, considering that the possibility of colliding with a following vehicle is high when the vehicle 100 stops suddenly by increasing the deceleration, it may be possible to put higher priority on controlling the time point at which the vehicle starts to decelerate than controlling the deceleration. In addition or alternatively, according to an example, controlling the time point at which the vehicle starts to decelerate and controlling the deceleration may be combined, and performed at the same time.

As described above, the various examples of the present disclosure propose the control of the vehicle for predicting an allowance space and for stopping within the allowance space when the straight stop type is selected to be the MRM type.

Through the control, when the vehicle 100 needs the MRM, it is possible to safely stop the vehicle within the allowance space.

Accordingly, various examples of the present disclosure disclose a vehicle that performs a minimal risk maneuver (MRM) to remove (or reduce) a risk and a method for operating the vehicle when a situation in which normal autonomous driving is impossible is detected during autonomous driving.

Various examples of the present disclosure disclose a method for predicting a stopping available space in an attempt to perform the straight stop through the minimal risk maneuver, when a situation in which normal autonomous driving is impossible is detected during autonomous driving, and for controlling the vehicle to stop within the allowance space.

Technical objects to be achieved by the present disclosure are not limited to the aforementioned objects, and those skilled in the art to which the present disclosure pertains may evidently understand other technical objects from the following description.

One example is a vehicle, including: at least one sensor; a controller configured to control operation of the vehicle; and a processor configured to be electrically connected to the at least one sensor and the controller.

In a situation where a minimal risk maneuver is needed, the processor may determine a minimal risk maneuver type, set an allowance space in which the vehicle stops based on the determined minimal risk maneuver type and control the vehicle to stop within the allowance space.

Another example is a method for operating a vehicle, including: determining a minimal risk maneuver type when a situation requiring the minimal risk maneuver occurs; setting an allowance space in which the vehicle stops based on the determined minimal risk maneuver type; and controlling the vehicle to stop within the allowance space.

According to various examples of the present disclosure, when a situation in which normal autonomous driving is impossible is detected during the autonomous driving, it is possible to minimize risk of the vehicle by executing a minimal risk maneuver, thereby improving the safety.

In one or more examples, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

When the examples are implemented in program code or code segments, it should be appreciated that a code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc. Additionally, in some examples, the steps and/or actions of a method or algorithm may reside as one or any combination or set of codes and/or instructions on a machine readable medium and/or computer readable medium, which may be incorporated into a computer program product.

For a software implementation, the techniques described herein may be implemented with modules (e.g., procedures, functions, and so on) that perform the functions described herein.

The software codes may be stored in memory units and executed by processors. The memory unit may be implemented within the processor or external to the processor, in which case it may be communicatively coupled to the processor via various means.

For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

What has been described above includes examples of one or more examples. It is, of course, not possible to describe every conceivable combination of components or methodologies for purposes of describing the aforementioned examples, but one of ordinary skill in the art may recognize that many further combinations and permutations of various examples are possible. Accordingly, the described examples are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

As used herein, the term to “infer” or “inference” refers generally to the process of reasoning about or inferring states of the system, environment, and/or user from a set of observations as captured via events and/or data. Inference may be employed to identify a specific context or action, or may generate a probability distribution over states, for example. The inference may be probabilistic-that is, the computation of a probability distribution over states of interest based on a consideration of data and events. Inference may also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, as used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution and a component may be localized on one computer and/or distributed between two or more computers. In addition or alternatively, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

What is claimed is:

1. An apparatus for controlling autonomous driving of a vehicle, the apparatus comprising:
at least one sensor;
a controller configured to control operation of the vehicle;
a processor configured to be electrically coupled to the at least one sensor and the controller,
wherein the processor is further configured to:
identify, based on a condition for a minimal risk maneuver being satisfied, a minimal risk maneuver type;
set, based on the identified minimal risk maneuver type, an allowance space in which the vehicle is able to stop;
output a signal associated with the allowance space; and
control, based on the signal, autonomous driving of the vehicle such that the vehicle stops within the allowance space.

2. The apparatus of claim 1, wherein the processor is further configured to:
for the minimal risk maneuver, select, based on the identified minimal risk maneuver type, one stop type among a stop within lane type, a shoulder stop type, or a straight stop type.

3. The apparatus of claim 2, wherein the processor is further configured to, based on the straight stop type being selected:
estimate a stopping available distance, a collision risk distance, and a lane departure distance;
determine a smallest distance among the estimated stopping available distance, the estimated collision risk distance, and the estimated lane departure distance, wherein the smallest distance is a longitudinal allowable distance; and
set, based on the longitudinal allowable distance, the allowance space.

4. The apparatus of claim 3, wherein the processor is configured to:
estimate the stopping available distance based on a relationship among a present vehicle velocity value, a deceleration value applied for the minimal risk maneuver, and a clearance distance value.

5. The apparatus of claim 3, wherein the processor is configured to:
select a collision risk spot at which the vehicle is at risk of colliding based on the vehicle traveling in a straight line;
estimate a first distance to the collision risk spot, wherein the first distance is the collision risk distance;
select a lane departure spot at which the vehicle is at risk of departing from a lane based on the vehicle traveling in a straight line; and
estimate a second distance to the lane departure spot, wherein the second distance is the lane departure distance.

6. The apparatus of claim 3, wherein the processor is further configured to:
set the allowance space further based on a lateral allowable distance, wherein the lateral allowable distance is estimated as a smaller value among:
a value representing a remaining width of a next lane after subtracting a width of another vehicle traveling in the next lane and a preset constant value from a width of the next lane, and
a maximum intrusion allowable range.

7. The apparatus of claim 3, wherein the processor is further configured to, based on a determination that the stopping available distance is the longitudinal allowable distance:
control, based on a preset deceleration value, the autonomous driving of the vehicle to decelerate for executing the minimal risk maneuver.

8. The apparatus of claim 7, wherein the processor is further configured to, based on a determination that the collision risk distance or the lane departure distance is the longitudinal allowable distance:
control autonomous driving of the vehicle to advance a time point at which the vehicle starts to decelerate for a minimal risk maneuver, or
control autonomous driving of the vehicle to decelerate more rapidly than the preset deceleration value for a minimal risk maneuver.

9. The apparatus of claim 8, wherein the processor is further configured to:
prioritize the control of the autonomous driving of the vehicle to advance the time point over the control of the autonomous driving of the vehicle to decelerate more rapidly than the preset deceleration value.

10. A method performed by an apparatus for controlling autonomous driving of a vehicle, the method comprising:
identifying, based on a condition for a minimal risk maneuver being satisfied, a minimal risk maneuver type;
setting, based on the identified minimal risk maneuver type, an allowance space in which the vehicle is able to stop;
outputting a signal associated with the allowance space; and
controlling, based on the signal, autonomous driving of the vehicle such that the vehicle stops within the allowance space.

11. The method of claim 10, wherein the minimal risk maneuver type comprises at least one of a stop within lane type, a shoulder stop type, or a straight stop type.

12. The method of claim 11, wherein the identifying the minimal risk maneuver type comprises selecting the straight stop type, and
wherein the setting the allowance space comprises:
estimating a stopping available distance, a collision risk distance, and a lane departure distance;
determining a smallest distance among the estimated stopping available distance, the estimated collision risk distance, and the estimated lane departure distance, wherein the smallest distance is a longitudinal allowable distance; and
setting, based on the longitudinal allowable distance, the allowance space.

13. The method of claim 12,
wherein the setting the allowance space comprises:
estimating the stopping available distance based on a relationship among a present vehicle velocity value, a deceleration value applied for the minimal risk maneuver, and a clearance distance value.

14. The method of claim 12, wherein the setting the allowance space comprises:
selecting a collision risk spot at which the vehicle is at risk of colliding based on the vehicle traveling in a straight line;
estimating a first distance to the collision risk spot, wherein the first distance is the collision risk distance;
selecting a lane departure spot at which the vehicle is at risk of departing from a lane based on the vehicle travelling in a straight line; and
estimating a second distance to the lane departure spot, wherein the second distance is the lane departure distance.

15. The method of claim 12, wherein the setting the allowance space further comprises:
identifying a smaller value among:
a value representing a remaining width of a next lane after subtracting a width of another vehicle traveling in the next lane and a preset constant value from a width of the next lane, and
a maximum intrusion allowable range; and
setting, based on the smaller value, the allowance space.

16. The method of claim 12, wherein the controlling the autonomous driving of the vehicle comprises:
based on a determination that the stopping available distance is the longitudinal allowable distance, controlling, based on a preset deceleration value, the autonomous driving of the vehicle to decelerate for executing the minimal risk maneuver.

17. The method of claim 16, wherein the controlling the autonomous driving of the vehicle comprises:
based on a determination that the collision risk distance or the lane departure distance is the longitudinal allowable distance,
controlling autonomous driving of the vehicle to advance a time point at which the vehicle starts to decelerate for a minimal risk maneuver, or
controlling autonomous driving of the vehicle to decelerate more rapidly than the preset deceleration value for a minimal risk maneuver.

18. The method of claim 17, wherein the controlling the autonomous driving of the vehicle comprises:
prioritizing the controlling the autonomous driving of the vehicle to advance the time point over the controlling the autonomous driving of the vehicle to decelerate more rapidly than the preset deceleration value.

19. The method of claim 13, wherein the stopping available distance increases as the present vehicle velocity value increases, and wherein the stopping available distance decreases as the deceleration value increases.

20. The method of claim 15, wherein the preset constant value comprises a clearance constant value of 0.75 meter.
